(19) United States
(12) Patent Application Publication
(10) Pub. No.: US 2024/0019565 A1
(43) Pub. Date: Jan. 18, 2024

(54) MOTION COMPENSATION FOR FAST TARGET DETECTION IN AUTOMOTIVE RADAR

(71) Applicant: QUALCOMM Incorporated, San Diego, CA (US)

(72) Inventors: Uri LEVY, Zichron Yaakov, Ha (IL); Ariel Yaakov SAGI, Haifa, HA (IL); Evyatar HEMO, Kiryat Bialik, HA (IL); Evgeny LEVITAN, Haifa, HA (IL)

(21) Appl. No.: 18/250,533

(22) PCT Filed: Dec. 10, 2021
(86) PCT No.: PCT/US2021/072855

§ 371 Date: Apr. 25, 2023

(30) Foreign Application Priority Data
Dec. 15, 2020 (IL) 279457

(51) Int. Cl. G01S 13/524; G01S 7/288; G01S 13/931; G01S 13/58; G01S 13/42

(52) U.S. Cl. CPC G01S 13/5242; G01S 7/2883; G01S 13/42; G01S 13/582; G01S 13/931

(57) ABSTRACT

A method of motion compensation for a Doppler radar system includes receiving, for each transmitted pulse of a set of transmitted pulses, a respective set of echo signals returned from a plurality of distance ranges, performing Doppler Fourier transforms on the sets of echo signals for the set of transmitted pulses to generate outputs that include detected signals in a plurality of velocity bins, and applying a respective pre-determined compensation phase vector to the detected signals in each velocity bin of the plurality of velocity bins. The respective pre-determined compensation phase vector applied to the detected signals in each velocity bin includes at least one of a first component proportional to a velocity of the velocity bin or a second component for compensating a phase compensation error associated with Doppler velocity aliasing.

### RELATED APPLICATIONS

This application claims the benefit of Israel patent application no. 279457, filed Dec. 15, 2020, entitled “Motion Compensation for Fast Target Detection in Automotive Radar,” which is assigned to the assignee hereof and incorporated by reference herein in its entirety.

### BACKGROUND

The present invention relates generally to the field of radars, and more specifically to motion compensation in Doppler radars.

Radar technology has wide application across different industries, such as automotive, medical, telecommunications, virtual reality (VR), augmented reality (AR), and many others. For example, radars may be used in autonomous driving vehicles to detecting objects in the surrounding environment of an autonomous driving vehicle. Radars may operate in environments where other types of sensing technology may fail or may not be adequate. For example, automotive radars may be capable of operating in environments where light-based sensors (e.g., cameras and light detection and ranging (LIDAR) systems) perform poorly, such as during heavy precipitation, reduced visibility, and the like.

Radars may measure the round trip return time to determine a range of an object. In addition, the use of Doppler measurement and processing techniques allows a radar system to determine the relative velocity of a target object. For example, a Doppler radar system may perform Doppler frequency detection using a bank of narrow digital filters. By measuring the Doppler frequency and/or the phase shift, a Doppler radar system is able to measure the relative velocity of objects that return echoes to the radar system, such as planes, vehicles, animals, or other objects.

### BRIEF SUMMARY

Techniques disclosed herein relates generally to radars, and more specifically to motion compensation techniques for improving the performance of Doppler radars in detecting high speed objects. According to certain aspects, a method of motion compensation for a Doppler radar system may include includes receiving, for each transmitted pulse of a set of transmitted pulses, a respective set of echo signals returned from a plurality of distance ranges, performing Doppler Fourier transforms on the sets of echo signals for the set of transmitted pulses to generate outputs that include detected signals in a plurality of velocity bins, and applying a respective pre-determined compensation phase vector to the detected signals in each velocity bin of the plurality of velocity bins. The respective pre-determined compensation phase vector applied to the detected signals in each velocity bin may include at least one of a first component proportional to a velocity of the velocity bin or a second component for compensating a phase compensation error associated with Doppler velocity aliasing.

According to certain aspects, a Doppler radar system may include a Doppler Fourier transform subsystem and a motion compensation subsystem. The Doppler Fourier transform subsystem may be configured to receive, for each transmitted pulse of a set of transmitted pulses, a respective set of echo signals returned from a plurality of distance ranges, and perform Doppler Fourier transforms on the sets of echo signals for the set of transmitted pulses. The outputs of the Doppler Fourier transforms may include detected signals in a plurality of velocity bins. The motion compensation subsystem may be configured to apply a respective pre-determined compensation phase vector to the detected signals in each velocity bin of the plurality of velocity bins. The respective pre-determined compensation phase vector applied to the detected signals in each velocity bin may include at least one of a first component proportional to a velocity of the velocity bin or a second component for compensating a phase compensation error associated with Doppler velocity aliasing.

According to certain aspects, a device for motion compensation main include means for receiving, for each transmitted pulse of a set of transmitted pulses, a respective set of echo signals returned from a plurality of distance ranges, means for performing Doppler Fourier transforms on the sets of echo signals for the set of transmitted pulses to generate outputs that include detected signals in a plurality of velocity bins; and means for applying a respective pre-determined compensation phase vector to the detected signals in each velocity bin of the plurality of velocity bins. The respective pre-determined compensation phase vector applied to the detected signals in each velocity bin may include at least one of a first component proportional to a velocity of the velocity bin or a second component for compensating a phase compensation error associated with Doppler velocity aliasing.

According to certain aspects, a non-transitory computer-readable medium may have instructions embedded thereon. The instructions, when executed by one or more processing units, may cause the one or more processing units to perform operations including receiving, for each transmitted pulse of a set of transmitted pulses, a respective set of echo signals returned from a plurality of distance ranges, performing Doppler Fourier transforms on the sets of echo signals for the set of transmitted pulses to generate outputs that include detected signals in a plurality of velocity bins, and applying a respective pre-determined compensation phase vector to the detected signals in each velocity bin of the plurality of velocity bins. The respective pre-determined compensation phase vector applied to the detected signals in each velocity bin may include at least one of a first component proportional to a velocity of the velocity bin or a second component for compensating a phase compensation error associated with Doppler velocity aliasing.

### BRIEF DESCRIPTION OF THE DRAWINGS

FIG. 1A illustrates an example of measuring the range and velocity of a vehicle using an automotive radar according to an embodiment.

FIG. 1B illustrates an example of a phase shift between the transmitted pulse and the returned echo.

FIG. 2A illustrates an example of radar data collection in a pulsed Doppler radar system.

FIG. 2B illustrates an example of a Doppler processing subsystem in a pulsed Doppler radar system.

FIG. 3A illustrates an example of a data matrix including received echoes of pulses from different ranges.

FIG. 3B illustrates an example of a range-Doppler map generated by performing fast Fourier transforms (FFTs) on the data matrix shown in FIG. 3A.

FIG. 4A illustrates an example of a pulse transmission sequence in an example of a multiple-input-multiple-output (MIMO) radar according to certain embodiments.

FIG. 4B illustrates an example of a data cube including echoes of sub-pulses of multiple pulses from different ranges and received by a MIMO radar.

FIG. 5A includes an image illustrating measuring ranges and velocities of objects in an example of an environment using an automotive radar according to certain embodiments.

FIG. 5B includes an example of a range-Doppler map illustrating ranges and velocities of objects measured by a Doppler radar on a vehicle in the example of the environment shown in FIG. 5A.

FIG. 5C includes an example of a map illustrating locations of dynamic objects measured by a Doppler radar on a vehicle in the environment shown in FIG. 5A.

FIG. 5D includes an example of a map illustrating locations of objects measured by a Doppler radar on a vehicle in the environment shown in FIG. 5A.

FIG. 6A includes an example of a range-Doppler map illustrating gain loss for fast dynamic objects measured by a Doppler radar.

FIG. 6B illustrates an example of a relationship between the gain and the velocity of an object measured by a Doppler radar.

FIG. 7A illustrates an example of a method of compensating residual phase shifts in Doppler radars according to certain embodiments.

FIG. 7B illustrates an example of a range-Doppler map.

FIG. 7C illustrates an example of the result of compensating the residual phases in Doppler radars according to certain embodiments.

FIG. 8 illustrates velocity aliasing in an example of a Doppler radar.

FIG. 9 illustrates an example of a result of compensating Type-I residual phases in the presence of Doppler aliasing according to certain embodiments.

FIG. 10 illustrates an example of a result of compensating residual phases in the presence of Doppler aliasing according to certain embodiments.

FIG. 11 illustrates an example of a Doppler processing system with motion compensation according to certain embodiments.

FIG. 12 illustrates an example of the outputs of a Doppler processing system with motion compensation according to certain embodiments.

FIG. 13 includes a flowchart illustrating an example of a method of compensating residual phases in a Doppler radar system according to certain embodiments.

FIG. 14 is a block diagram of an embodiment of a computer system, which can be utilized in embodiments described herein.

Like reference symbols in the various drawings indicate like elements, in accordance with certain example implementations.

### DETAILED DESCRIPTION

Techniques disclosed herein relates generally to radars, and more specifically to motion compensation techniques for improving the performance of Doppler radars in detecting high speed objects. Various inventive embodiments are described herein, including devices, systems, subsystems, methods, instructions, code, programs, units, engines, computer-program products, computer-readable storage media, data carrier signals, and the like.

Doppler radar systems, such as automotive radar systems, may suffer from gain loss when detecting moving targets, where the gain loss may be related to the velocities of the moving targets. In addition, a pulse Doppler radar can be ambiguous in either the range or the Doppler frequency, where the ambiguity may depend on the selected pulse repetition frequency (PRF). For example, Doppler ambiguity may occur when the velocity of the target is greater than the maximum Doppler velocity measuring interval, which may be proportional to the PRF. Thus, a pulse Doppler radar may only effectively detect targets moving at up to a certain maximum velocity. As such, a fast target may either be detected as a very weak target (e.g., a small vehicle, while it is actually a large vehicle) or may not be detected at all, which may lead to potentially life-threatening risks. Existing techniques may assume that the radar output includes an inherent ambiguity and may use probabilistic tools in a perception layer to identify the ambiguity. But the performance of these techniques is limited by the quality of the radar outputs. If a target is not detected by a radar, the perception layer would not be aware of the existence of the target. Therefore, it is desirable to minimize the effect of the gain loss for high speed objects in the radar receiver level.

Techniques disclosed herein can compensate for or reduce the gain loss of a fast moving target in a pulse Doppler radar, such as an automotive multiple-input-multiple-output (MIMO) radars. The gain loss may be at least partially caused by a residual phase, which may include at least one of two types. The first type is referred to herein as the Type-I residual phase, which is associated with every moving target and may be proportional to the velocity of the moving target. The second type is referred to herein as the Type-II residual phase, which is associated with Doppler ambiguity for targets moving faster than the maximum velocity of the radar and may be similar for targets with velocities in a certain range. According to certain embodiments disclosed herein, two compensation phases may be applied to pulse signals received by the radar, for example, after the received pulse signals have been cross-correlated with the transmitted signals, or may be applied to the results of the Doppler FFT of the received pulse signals. The two compensation phases may be chosen as the opposite phase of the Type-I residual phase and the opposite phase of the Type-II residual phase, respectively. Thus, if a residual phase of any of the two types is present in the received signal, it may be canceled by its opposite phase in the compensation phases.

According to certain embodiments, in order to determine the appropriate compensation phases to be applied to the received pulse signals or the output signals of the Doppler FFT of the received pulse signals without knowing the target velocities in advance, compensation phases corresponding to all possible target velocities can be pre-determined and applied to the detected signals (e.g., cross-correlated pulses or the output signals of the Doppler FFT). Therefore, if a target with a certain velocity is present in the environment, a specific pre-determined compensation phase for the velocity may be applied to the corresponding detected signals (e.g., cross-correlated pulses or the output signals of the Doppler FFT). If no targets are moving at a certain velocity in the environment and thus the power of the detected signals associated with the velocity is very low, applying the compensation phase to the detected signals would not cause any detrimental side effects. In this way, the residual phases of targets presented in the environment may be compensated for, with little or no side effects.

Several illustrative embodiments will now be described with respect to the accompanying drawings, which form a part hereof. While some embodiments in which one or more aspects of the disclosure may be implemented as described below, other embodiments may be used, and various modifications may be made without departing from the scope of the disclosure.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

In a radar system, a signal source may transmit RF signals to a target. When the signal source and/or the target are moving with respect to each other, Doppler effect may occur. For example, when the signal source and the target are getting closer, each wave may take a slightly shorter time to reach the target than the previous wave. Therefore, the time between the arrivals of successive wave crests at the target (or at the signal source when being reflected back) may be reduced, causing an increase in the frequency of the received RF signals. When the distance between the signal source and the target is getting longer, each wave may take a slightly longer time to reach the target than the previous wave. Therefore, the time between the arrivals of successive wave crests at the target (or returned to the signal source) may be increased, causing a decrease in the frequency of the received signals. Doppler effect has been used in radar systems to measure the velocities of targets. During the operation of a radar system, a radar beam (e.g., pulses having a certain carrier frequency) is transmitted towards a target, such as a moving vehicle approaching or receding from the radar system. The Doppler frequency shift may be measured and used to calculate the target's velocity.

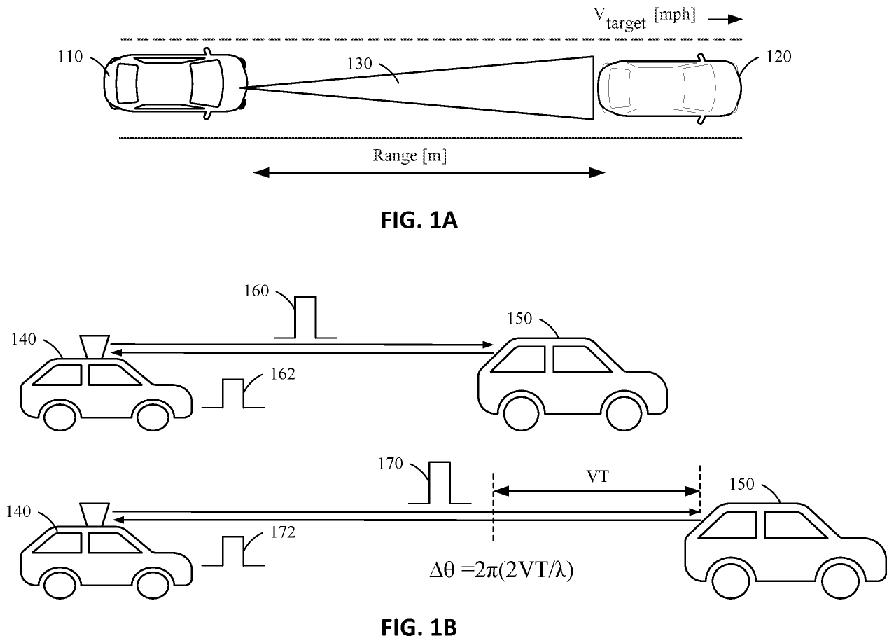

FIG. 1A illustrates an example of measuring the range and velocity of a vehicle using a Doppler radar according to an embodiment. A vehicle 110 may include an automotive Doppler radar installed thereon, which may transmit an RF signal 130 towards a target vehicle 120. Target vehicle 120 may have a speed v_{target} relative to vehicle 110. RF signal 130 may include a pulse that includes a carrier signal modulated by, for example, a chirp signal. The pulse may have a certain pulse width. Target vehicle 120 may reflect a portion of RF signal 130. Based on the time delay between the transmission of RF signal 130 by the automotive Doppler radar transmitter at vehicle 110 and the receiving of the returned portion of RF signal 130 at the automotive Doppler radar receiver, the distance between vehicle 110 and target vehicle 120 may be determined. Based on the frequency and/or phase shift of the returned portion of RF signal 130 caused by the Doppler effect, the relative velocity of target vehicle 120 with respect to vehicle 110 may be determined.

Because the doppler shift affects the wave incident upon the target as well as the wave reflected back to the automotive Doppler radar, the change in the frequency (Δf) observed by a radar that transmits signals with a carrier frequency (f₀) due to a target moving at a relative velocity v may be twice of that perceived by the target and may be determined according to Δf=2v×f₀/c, where c is the speed of electromagnetic waves in free space.

A pulse Doppler radar may transmit a series of pulses that are separated by a distance din the radial direction from the radar. The distance d may be a function of the rate at which the pulses are transmitted, which is generally referred to as the pulse repetition frequency (PRF), where the inverse of the PRF is the pulse repetition interval (PRI) T_{PRI}. The distance d between adjacent pulses may be determined according to d=c/PRF=c×T_{PRI}. Some of the energy of the transmitted pulses may be reflected or deflected back to the radar. The maximum range to which a pulse can travel and return before the next pulse is transmitted is one-half of the separation distance d. This maximum range may be defined as Rₘₐₓ=c/(2×PRF). When the range of the target is greater than the maximum range, range folding may occur, and the echo of a pulse by the target may not be distinguished from an echo of a later transmitted pulse by a target at a shorter distance from the radar. One way to alleviate the range folding is to decrease the PRF until the maximum range Rₘₐₓ is beyond all scattering regions. The achievable range resolution (also referred to as the blind range) of a pulse Doppler radar may be Rₘᵢₙ=cτ/2, where τ is the pulse width.

The Doppler velocity resolution Av (in mph or m/s) of a pulse Doppler radar may depend on the pulse repetition interval T_{PRI}, the number of pulses N, and the wavelength λ of the carrier signal according to

$$Δ v = \frac{λ}{2 N \times {T}_{PRI}} .$$

A radar may be able to distinguish two targets with a velocity difference greater than Δv. The product of the pulse repetition interval T_{PRI} and the number of pulses N may be referred to as the coherent processing interval (CPI). A larger CPI may result in a better resolution (i.e., a smaller Δv). The CPI can be increased by increasing the pulse repetition interval T_{PRI} (which may also increase Rₘₐₓ) and/or the number of pulses N. However, the CPI may not be too long because a driver or driving system needs to be informed on the presence of targets as quickly as possible so that the driver or the driving system can respond accordingly in time.

The maximum Doppler velocity measuring interval Vₘₐₓ (also referred to as the Nyquist interval) of a Doppler radar system is also related to the PRF and the radar wavelength λ of the carrier signal according to Vₘₐₓ=±PRF×λ/4. A radar may only unambiguously measure targets moving up to the maximum Doppler velocity measuring interval Vₘₐₓ, which may also be determined by

$$\vert {V}_{max} \vert = \frac{N}{2} Δ v .$$

In an automotive Doppler radar, Vₘₐₓ may be, for example, about 50 mph or higher. Targets moving faster than Vₘₐₓ may appear as if they were moving at a lower velocity, due to the Doppler aliasing. When the PRF decreases, Vₘₐₓ may also decrease, and Doppler velocity aliasing may start to occur at lower velocities.

Increasing the PRF (or decreasing the PRI) may increase the Vₘₐₓ, but may decrease the maximum range Rₘₐₓ and also decrease the velocity resolution (increase Av). For a Doppler radar system having a specific wavelength, the product of Vₘₐₓ and Rₘₐₓ is a constant ±c×λ/8. As such, increasing Rₘₐₓ may decrease Vₘₐₓ and vice versa. This tradeoff between Vₘₐₓ and Rₘₐₓ is referred to as the “Doppler dilemma.”

FIG. 1B illustrates an example of a phase shift between a transmitted pulse and a returned echo. In the example shown in FIG. 1B, a radar on a first vehicle 140 may transmit a first pulse 160 towards a second vehicle 150. First pulse 160 may be partially reflected by second vehicle 150, and the reflected portion of first pulse 160 may be received by the radar on first vehicle 140 as an echo pulse 162 at a later time. When there is a relative velocity V between first vehicle 140 and second vehicle 150, the distance between first vehicle 140 and second vehicle 150 may be changed by a value VT when a second pulse 170 is transmitted at a time interval T after first pulse 160 is transmitted. Thus, second pulse 170 may need to travel a distance 2×VT longer than first pulse 160 (or 2×VT/λ, wavelengths more than first pulse 160) before being received by the radar on first vehicle 140. As such, an echo pulse 172 of second pulse 170 reflected by second vehicle 150 and received by first vehicle 140 may be phase-shifted by Δθ=2π×(2VT/λ) radians compared to echo pulse 162. The Doppler frequency shift f d can be determined from the phase shift according to

$${f}_{d} = \frac{Δ θ}{T} = \frac{4 π V}{λ} = \frac{4 π {f}_{0} V}{c} .$$

The amplitude of an echo pulse received by the radar may be described by

$$I = {I}_{0} sin ( \frac{4 π ( {x}_{0} + V T )}{λ} ) = {I}_{0} sin ( {θ}_{0} + Δθ ) ,$$

where I₀ is the amplitude of a returned pulse from a target with V=0, x₀ is the distance between the radar and a target, θ₀ is the phase of the first returned pulse, T is the time interval between the first transmitted pulse and a second transmitted pulse, and Δθ=4πVT/λ is the relative phase shift of the second returned pulse (e.g., echo pulse 172) with respect to the first returned pulse (e.g., echo pulse 162). Thus, the power of the returned pulse received by the radar receiver may be a function of the phase shift Δθ, which in turn is a function of the velocity V of the target (e.g., second vehicle 150).

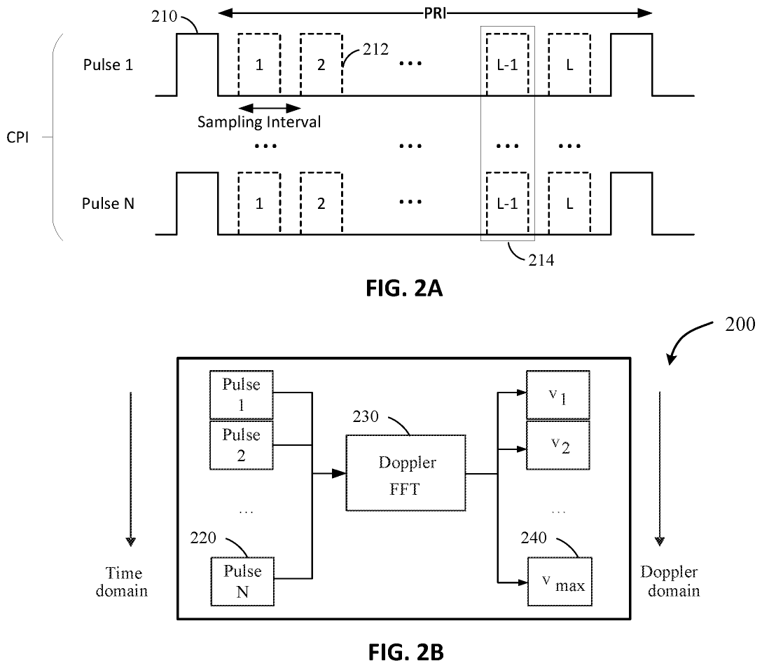

FIG. 2A illustrates an example of radar data collection in a pulsed Doppler radar system. As illustrated in FIG. 2A, for each pulse 210 of N pulses in a coherent processing interval, the returned pulses (also referred to as echoes) may be sampled at a certain sampling interval during the pulse repetition interval to capture L samples 212 before a returned pulse of the next transmitted pulse 210 is received by the radar receiver. The returned pulses may be returned by objects in various ranges, and the N returned pulses of the N transmitted pulses returned from a same range 214 may have different phase shifts due to the relative movement of the targets. The N returned pulses of the N transmitted pulses returned from each range 214 may be captured and processed, for example, by performing a fast Fourier transform (FFT), to convert the time-domain information to Doppler frequencies or velocities.

FIG. 2B illustrates an example of Doppler processing subsystem 200 in a pulsed Doppler radar system for processing measured pulses. Doppler processing subsystem 200 may include a Doppler FFT unit 230. Doppler FFT unit 230 may receive the captured samples 220 for each of N transmitted pulses and perform multiple FFTs on captured sample 220 to convert the time domain information to Doppler frequencies or velocities in different velocity bins 240. For example, if L samples are captured for each transmitted pulse of the N transmitted pulses, L one-dimensional Doppler FFTs may be performed Doppler FFT unit 230, where N captured samples corresponding to the N transmitted pulses returned from a same range may be used in each one-dimensional Doppler FFT. The L one-dimensional Doppler FFTs may be performed as a two-dimensional Doppler FFT.

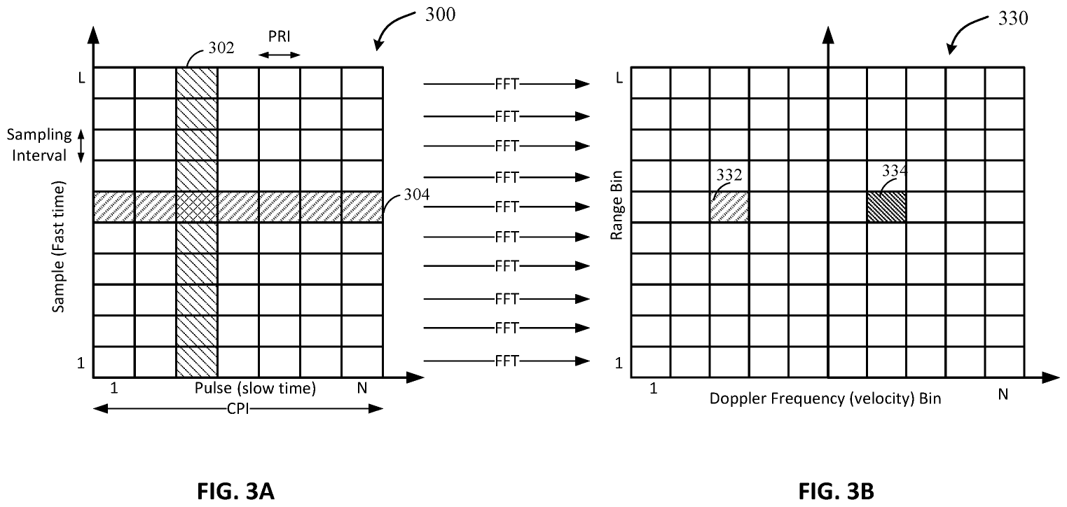

FIG. 3A illustrates an example of a data matrix 300 including echoes of pulses from various ranges. In FIG. 3A, the horizontal axis of data matrix 300 may correspond to the transmitted pulses in a coherent processing interval. The pulses are transmitted at a pulse repetition frequency as described above, where the time delay between two consecutive pulses is the pulse repetition interval. The total time for transmitting the N pulses is the coherent processing interval. The vertical axis of data matrix 300 may correspond to the captured echoes, which may be captured at a certain sampling interval that is much shorter than the pulse repetition interval. Thus, the horizontal axis of data matrix 300 may be referred to as the slow time and the vertical axis of data matrix 300 may be referred to as the fast time. The captured samples for a transmitted pulse may fall within different range bins because they are returned from different range intervals. In the illustrated example, each column 302 of data matrix 300 may correspond to a transmitted pulse n, where n is from 1 to N. L samples may be captured for each of the N transmitted pulses. Thus, each column 302 may include L range bins. Each row 304 of data matrix 300 may correspond to a same range bin for the N transmitted pulses.

A Doppler FFT may be performed on each row 304 of data matrix 300. For example, if the N captured samples for a range bin l are {x_{l,0}, x_{l,1}, . . . x_{l,N-1}}, a length-N FFT of the N captured samples may result in:

$${X}_{l , n} = \frac{1}{N} {\sum }_{k = 0}^{N - 1} {x}_{l , k} {e}^{- i 2 π k n / N} ,$$

where X_{l,n} is the detected signal in range bin l and frequency (or velocity) bin n, and n may be −[N/2], −[N/2]+1, . . . , [(N−1)/2]−1, or [(N−1)/2], which may correspond to the 1st frequency bin to the Nth frequency bin. In other words, after the Doppler FFT, there may be the same number of output signals as the captured samples, where the output signals may include frequency or velocity information in their phases.

FIG. 3B illustrates an example of a range-Doppler map 330 generated by performing Doppler FFTs on data matrix 300 shown in FIG. 3A. As described above, for moving targets, the returned echoes corresponding to a same range bin but from different pulses may have different phase shifts, which may be converted to frequency information by the Doppler FFT. As illustrated, an FFT may be performed on the echoes from a same range interval over the coherent processing interval during which N pulses may be transmitted and returned. The frequency domain information of the FFT results may be filtered into N frequency bins (or velocity bins). In the illustrated example, two moving targets in a same range interval but having different velocities may be represented by two elements in a same range bin but different velocity bins in range-Doppler map 330, where a first moving target may move away from the radar at a first velocity (e.g., represented by a negative relative velocity) and may be represented by an element 332 in range-Doppler map 330, whereas a second moving target may approach the radar at a second velocity (e.g., represented by a positive relative velocity) and may be represented by an element 334 in range-Doppler map 330.

In many radar systems, range FFT and/or direction-of-arrival (DoA) FFTs may also be performed. Thus, a three-dimensional (3D) array of spectrum values, also referred to as a radar 3D image, may be generated and used to produce range, velocity, and direction-of-arrival estimates for targets of the radar system. In some radar systems, the transmitted pulses may be modulated, for example, by a chirp signals, in order to distinguish returned echoes from different transmitted pulses.

As described above, the achievable range resolution of a pulse Doppler radar may be Rₘᵢₙ=cτ/2, where τ is the pulse width. A radar using narrower pulses may achieve a better range resolution. In a time-division-multiplexing multiple-input-multiple-output (TDM-MIMO) radar, each pulse may include multiple short sub-pulses transmitted in a plurality of MIMO cycles (or time slots). The TDM-MIMO radar may transmit a short sub-pulse by a subarray of antennas in each time slot, and may cycle through each subarray of antennas of the radar to transmit the multiple sub-pulses in each pulse. MIMO radars may achieve better spatial (e.g., range and angle) and Doppler (e.g., velocity) resolutions.

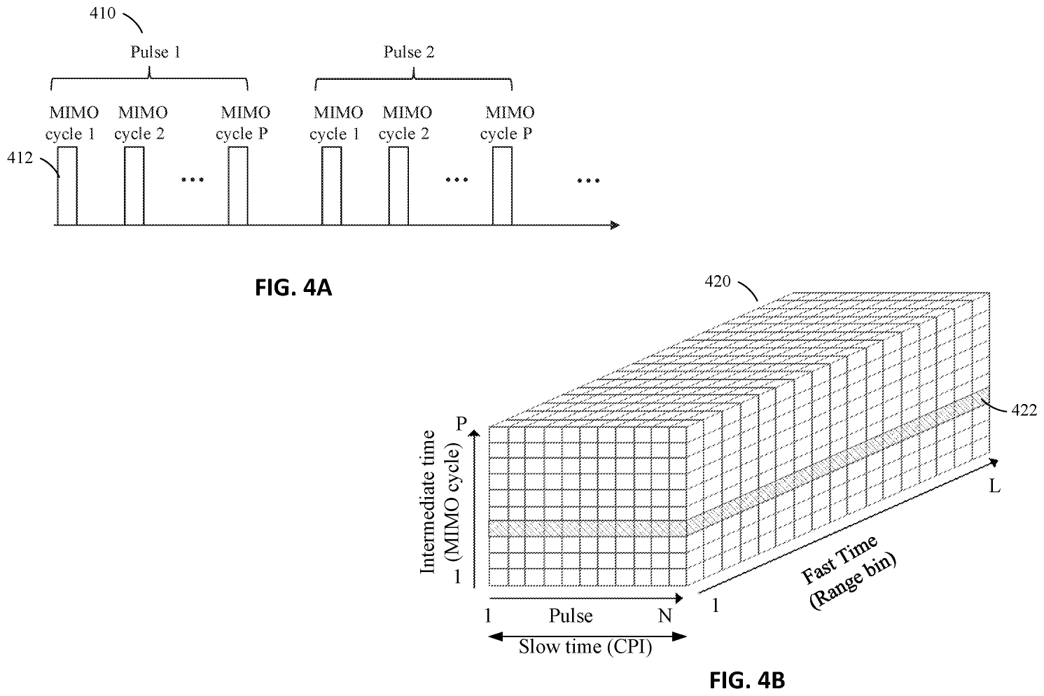

FIG. 4A illustrates an example of a pulse transmission sequence in an example of a MIMO radar according to certain embodiments. As described above, in a TDM-MIMO radar, each pulse 410 of N pulses 410 in a coherent processing interval may include multiple (e.g., P) MIMO cycles 412 (or time slots), where a short sub-pulse may be transmitted during each MIMO cycle 412 by, for example, an antenna or a subarray of an antenna array. As also described above with respect to FIGS. 2A and 3A, the echoes of each short sub-pulse from different ranges may be captured by the radar receiver at a certain sampling interval (fast time). Therefore, a two-dimensional data matrix as described above with respect to FIG. 3A may be generated for each MIMO cycle of the P MIMO cycles across the N pulses, where one dimension of the two-dimensional data matrix corresponds to the pulse (slow time) and the other dimension of the two-dimensional data matrix corresponds to the range bin (fast time). Thus, a three-dimensional data cube may be generated for the P MIMO cycles, where the third dimension corresponds to the MIMO cycle (intermediate time).

FIG. 4B illustrates an example of a data cube 420 including echoes of sub-pulses of multiple pulses from various ranges. Compared with the two-dimensional data matrix 300, data cube 420 may include an additional dimension corresponding to the MIMO cycle (intermediate time). Each layer 422 in data cube 420 may correspond to a pth MIMO cycle of a pulse and may be similar to the two-dimensional data matrix 300 shown in FIG. 3. In the illustrated example, there may be N pulses in the CPI, each pulse may include P sub-pulses transmitted in P MIMO cycles, and L echo signals may be captured for each sub-pulse transmitted in a MIMO cycle.

A two-dimensional FFT may be performed for each layer 422 of data cube 420 as described with respect to FIGS. 3A and 3B, where each layer 422 may correspond to one MIMO cycle across all N pulses. For example, L one-dimensional FFTs may be performed as described above, where each one-dimensional FFT may be performed on N echoes each corresponding to a sub-pulse in each pulse of N pulses. The two-dimensional FFT for each layer 422 (or MIMO cycle) may yield a respective range-Doppler map as shown in FIG. 3B. The P range-Doppler maps generated using the P layers of data (corresponding to the P MIMO cycles) in data cube 420 may then be averaged or otherwise merged to generate an overall range-Doppler map. Due to the high resolution and large field of view that an imaging radar needs to cover in automotive applications, many automotive imaging radars may use the TDM-MIMO cycles described above.

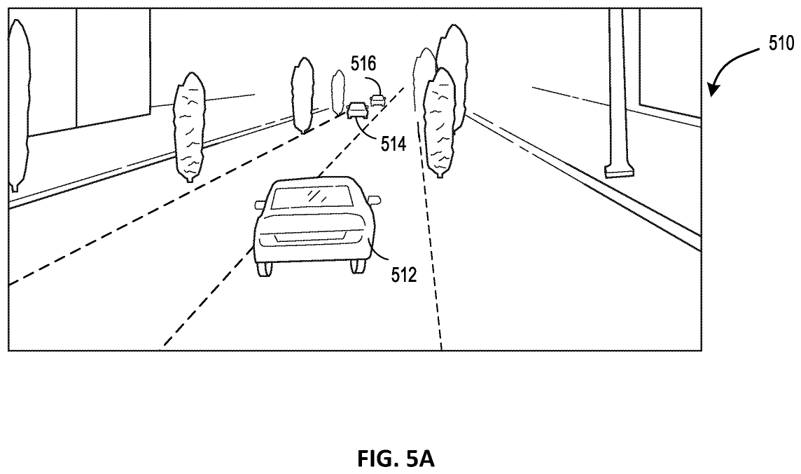

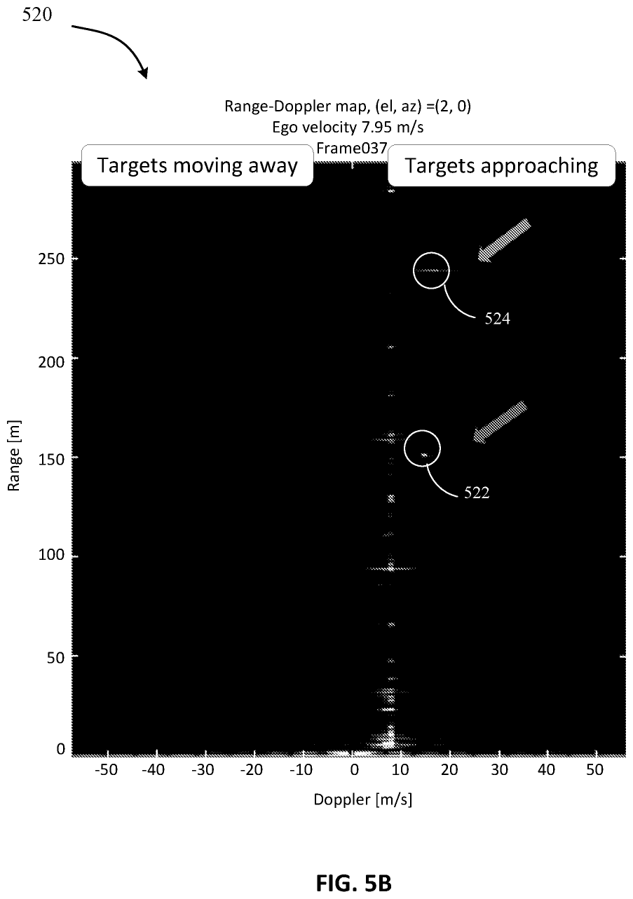

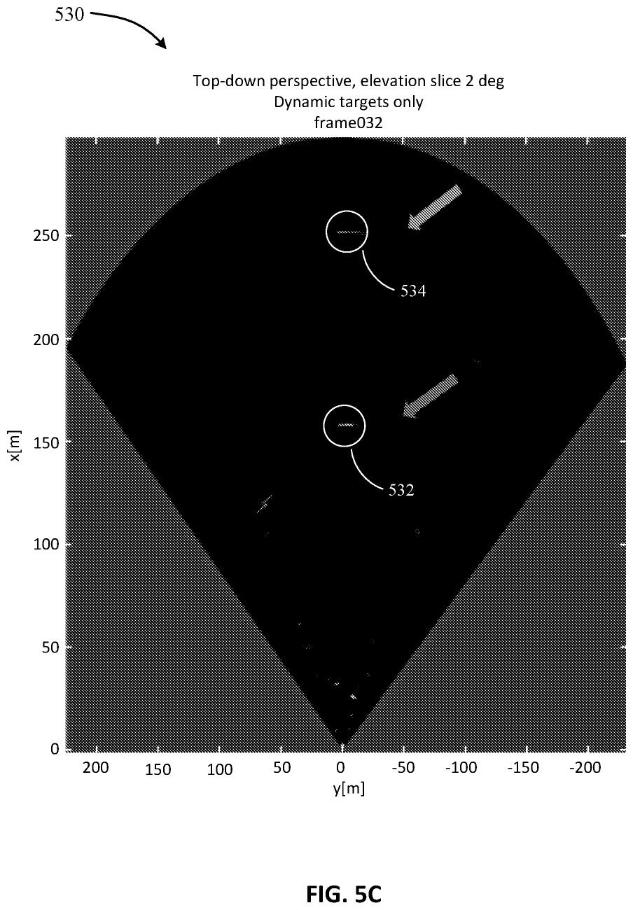

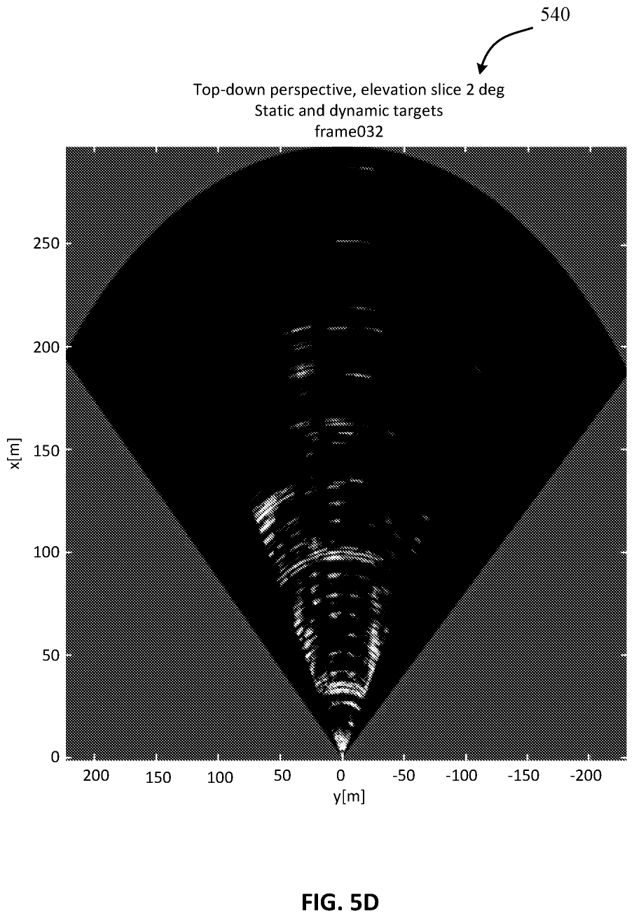

FIG. 5A includes an image 510 illustrating measuring ranges and velocities of objects in an example of an environment using an automotive radar according to certain embodiments. In the illustrated example, a first vehicle 512 may have an automotive radar installed thereon, which may be used to detect objects in the surrounding environment and measure the relative velocities of the detected objects. In the illustrated example, two other vehicles 514 and 516 may travel on the road, where static objects, such as trees, light poles, or other objects that are stationary, may be on the sides of the road.

FIG. 5B includes an example of a range-Doppler map 520 illustrating ranges and velocities of objects measured by a Doppler radar on first vehicle 512 in the environment shown in FIG. 5A. FIG. 5B shows the ranges and relative velocities of objects detected in the environment, including both static objects and dynamic objects. For example, FIG. 5B shows two bright spots 522 and 524 corresponding to vehicles 514 and 516, respectively. Bright spots 522 and 524 may correspond to different ranges and similar velocities. For example, bright spot 522 may indicate that vehicle 514 is at about 150 meters away from first vehicle 512 and is approaching first vehicle 512 at a relative velocity about 15 meters per second (m/s). Bright spot 524 may indicate that vehicle 516 is at about 250 meters away from first vehicle 512 and is approaching first vehicle 512 at a relative velocity about 15 meters per second (m/s). Static objects, such as trees, may approach first vehicle 512 due to the movement of first vehicle 512, and may be shown by bright spots corresponding to different ranges but at a same velocity (e.g., about 8 m/s, which is the velocity of first vehicle 512).

FIG. 5C includes an example of a map 530 illustrating locations of dynamic objects measured by the Doppler radar on first vehicle 512 in the environment shown in FIG. 5A. In map 530, the y axis corresponds to the horizontal direction and the x-axis corresponds to the vertical (or longitudinal) direction. Map 530 only shows the dynamic objects. In the illustrated example, two bright spots 532 and 534 are shown, which may correspond to vehicles 514 and 516, respectively. Map 530 shows that vehicles 514 and 516 are approximately aligned with first vehicle 512 in the horizontal direction and are about 150 meters and 250 meters, respectively, from first vehicle 512 in the longitudinal direction.

FIG. 5D includes an example of a map 540 illustrating locations of objects measured by the Doppler radar on first vehicle 512 in the environment shown in FIG. 5A. In map 540, the y axis corresponds to the horizontal direction and the x-axis corresponds to the vertical (or longitudinal) direction. Map 540 shows all dynamic objects and static objects detected by the Doppler radar, including objects in different view angles.

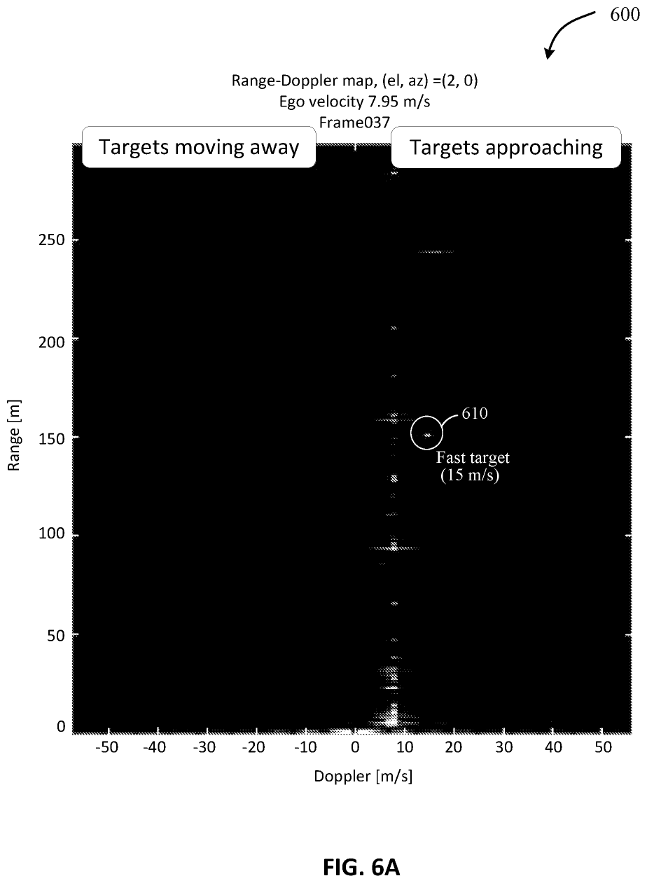

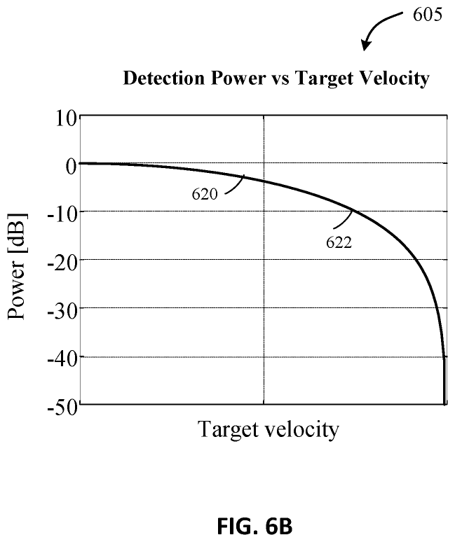

FIG. 6A includes an example of a range-Doppler map 600 illustrating gain loss for fast dynamic objects measured by a Doppler radar. As described above, the power of a returned pulse may be a function of the phase shift, which may in turn depend on the velocity of the object. Moving objects may impose residual phases between sub-pulses in the MIMO cycles, and equivalently, between pulses. The residual phase of the echoes of the pth sub-pulse transmitted in the pth MIMO cycle may be a function of the velocity of a target and may become larger as the target moves faster according to:

$$Δφ ( {v}_{target} ) = \frac{4 π p {T}_{PRI}}{λ} \times {v}_{target} = \frac{4 π p {T}_{PRI}}{λ} \times k Δ v ,$$

where T_{PRI} is the pulse repetition interval, v_{target} is the relative velocity of the target, k is the Doppler velocity bin number (or the pulse number), and Δv is the Doppler velocity resolution as described above. Δφ(v_{target}) may be referred to herein as the Type-I residual phase and may exist for any v_{target}. The detected power of a moving target may be a function of the Type-I residual phase as the gain may become smaller by a factor |e^{iΔφ(v}^{_{target}}⁾|≤1. Therefore, the gain loss may be zero only for static targets. For faster targets, the residual phases may be larger and the gain losses may be higher. For very fast targets, the gain losses may be too high for the targets to be detected. Thus, as illustrated in FIG. 6A, faster targets, such as a target 610, may have a lower power and thus a lower brightness in the map, compared to a similar target at a similar range but with a lower velocity.

FIG. 6B includes a chart 605 illustrating an example of a relationship between the gain and the velocity of an object measured by a Doppler radar. A curve 620 in FIG. 6B shows that, as the velocity of the target increases, the power of the detected signal may gradually decrease to a very small value. For example, a point 622 on curve 620 indicates that, at the corresponding velocity, the gain loss may be about 10 dB.

According to certain embodiments, the Type-I residual phase may be compensated for by adding a compensation phase to the phase of the detected signal, where the compensation phase may be the opposite of the Type-I residual phase, such that the Type-I residual phase may be removed.

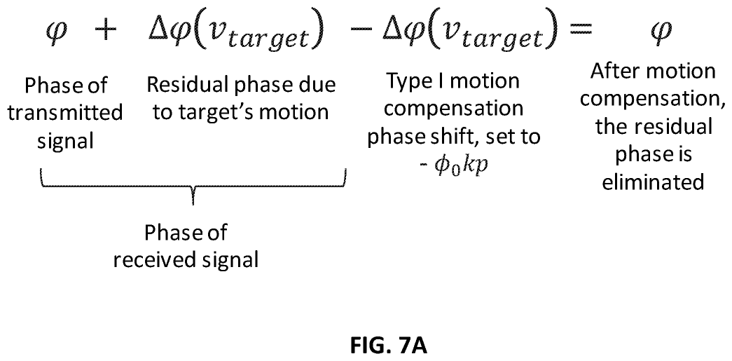

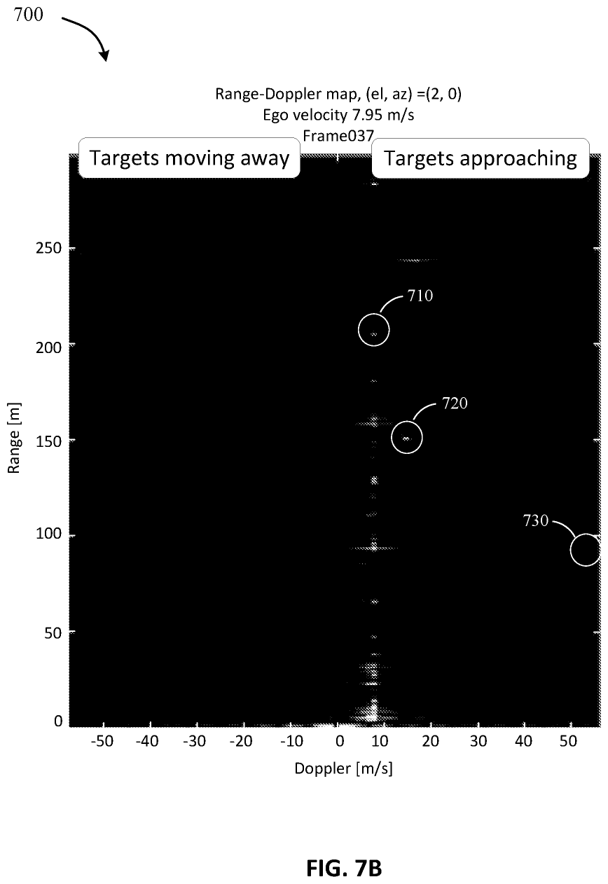

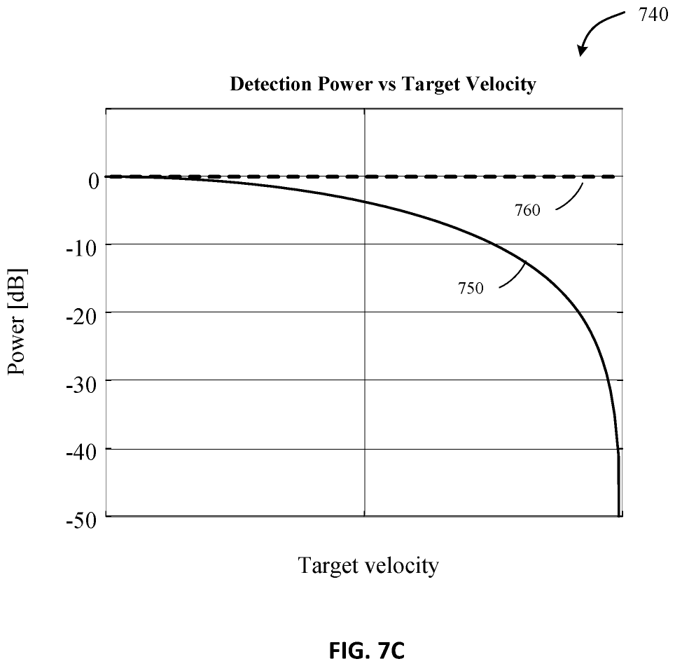

FIG. 7A illustrates an example of a method of compensating residual phases in Doppler radars according to certain embodiments. As illustrated, the phase of a detected signal (e.g., in a velocity bin of a range-Doppler map generated by performing a Doppler FFT for a MIMO cycle as described above with respect to FIG. 4B) may include two terms. The first term φ is the phase of the transmitted signal. The second term Δφ(v_{target}) is the Type-I residual phase caused by the motion of the target as described above. Thus, if the velocity of a target v_{target} is known, a compensation phase −Δφ(v_{target}) may be added to the phase of a detected signal by multiplying the detected signal with e^{-iΔφ(v}^{_{target}}⁾. After cross-correlating the phase-compensated signal with the transmitted signal, the residual phase may be cancelled by the compensation phase. As such, the overall phase of the detected signal may become φ for targets at all velocities.

However, the velocity of a target may not be known in advance, and thus the compensation phase may not be known in advance either. Thus, it can be difficult to directly apply the residual phase compensation to the captured time domain signals, before knowing the velocity of the target to be compensated for. According to certain embodiments, the compensation phase may be determined for each column (or velocity bin) of a respective range-Doppler map for each MIMO cycle. Thus, the phase shifts for all possible target velocities may be pre-determined and applied to the detected signals, such as the cross-correlated pulses or the output signals of the Doppler FFT. If a target with a certain velocity is present in the environment, a specific pre-determined compensation phase corresponding to the velocity may be applied to the corresponding detected signals to compensate the residual phase. If no targets are moving at a certain velocity in the environment and thus the power of the detected signals associated with the velocity is very low, applying the pre-determined compensation phase for the velocity to the corresponding detected signals would not cause any detrimental side effects. In this way, the residual phases of targets moving at any velocities in the environment may be compensated for, with little or no side effect. As such, the power of the detected signal may be equalized for similar targets having any velocities.

FIG. 7B illustrates an example of a range-Doppler map 700. Each point in range-Doppler map 700 may correspond to an object at a certain range interval from the Doppler radar and having a certain relative velocity with respect to the Doppler radar. Each range interval may correspond to a sample interval, and each velocity interval may correspond to a kth velocity bin of the N velocity bins of the Doppler FFT. A compensation phase may be determined for each column (corresponding to a respective velocity bin) in range-Doppler map 700. For example, points 710, 720, and 730 in range-Doppler map 700 may be in different velocity bins and may have different associated Type-I residual phases.

In the TDM-MIMO Doppler radar described above, it is determined that the residual phase of the detected signal in the kth velocity bin of the range-Doppler map for the pth MIMO cycle (or corresponding to the pth MIMO cycle and the kth pulse) may be

$$\frac{4 π p {T}_{PRI}}{λ} \times {v}_{target} or \frac{4 π k p {T}_{PRI}}{λ} \times Δ v .$$

Thus, the compensation phase can be the opposite of this residual phase, such as

$$- \frac{4 π k p {T}_{PRI}}{λ} \times Δ v .$$

Thus, as shown in r IG. 7A, the compensation phase for the Type-I residual phase may be set to ϕ₀kp for the detected signal at the kth velocity bin in the range-Doppler map for the pth MIMO cycle, where ϕ₀ may be a constant, such that:

φ+Δφ(v_{target})−ϕ₀kp=φ.

Since the Type-I residual phase may be

$$Δφ ( {v}_{t a r g e t} ) = \frac{4 π p {T}_{P R I}}{λ} \times {v}_{target} or \frac{4 π p {T}_{P R I}}{λ} \times k Δ v$$

for the pth MIMO cycle and the kth velocity bin, ϕ₀ may be set to

$$\frac{4 π {T}_{PRI} Δ v}{λ} .$$

### Because

$$Δ v = \frac{λ}{2 N \times {T}_{PRI}} ,$$

ϕ₀ may be set to

$$\frac{2 π}{N} .$$

FIG. 7C includes a chart 740 illustrating the result of an example of compensating the residual phase shift in Doppler radars according to certain embodiments. In chart 740, a curve 750 illustrates the power of the detected signal of a radar receiver (without motion compensation) as a function of the velocity of the target that causes the detected signal. As describe above and shown by curve 750, the power of the detected signal may decrease as the velocity of the target increases. A line 760 illustrates the power of the detected signal of a radar receiver with the Type-I residual phase compensation described above, as a function of the velocity of the target that causes the detected signal. As shown by FIG. 7A and line 760 in FIG. 7C, if the velocity of a target can be accurately determined, the phase and the power of the detected signal may remain constant for different target velocities after the Type-I residual phase compensation.

However, as described above, a radar may only unambiguously measure targets moving at speeds up to the maximum Doppler velocity measuring interval Vₘₐₓ, where

$$\vert {V}_{max} \vert = \frac{N}{2} Δ v .$$

Targets moving faster than the maximum velocity Vₘₐₓ may appear as if they were moving at a lower velocity, due to the Doppler aliasing.

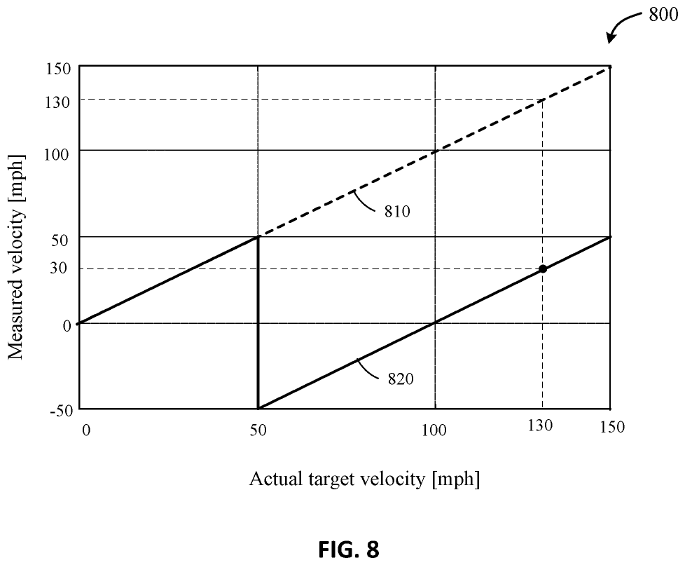

FIG. 8 includes a chart 800 illustrating examples of velocity aliasing in a Doppler radar. The horizontal axis of chart 800 corresponds to the actual velocity of a target, and the vertical axis corresponds to the measured velocity of the target by the Doppler radar. A line 810 in FIG. 8 shows the desired measured velocity for each corresponding actual velocity of the target. A curve 820 shows the measured velocity for each corresponding actual velocity of the target. In the example shown in FIG. 8, the Vₘₐₓ of the Doppler radar is about 50 mph. Thus, when the actual velocity of the target is between 0 and about 50 mph, the measured velocity may be the same as the actual velocity. When the actual velocity of the target is between about 50 and about 100 mph, the measured velocity may be between about −50 and 0 mph. When the actual velocity of the target is between about 100 and about 150 mph, the measured velocity may be between 0 and 50 mph. For example, when Vₘₐₓ of the Doppler radar is 50 mph and v_{target} is about 130 mph, the target measured by the Doppler radar may appear to be moving at only about 30 mph.

FIG. 8 shows that, for a target moving at a velocity greater than the Vₘₐₓ of the radar, the actual velocity of the target may be different from the measured velocity. Thus, the actual Type-I residual phase of the detected signal for a fast target may be φ+Δφ(v_{actual}), but the measured velocity v_{measured} may be different from the actual velocity v_{actual}, and thus the compensation phase Δφ(v_{measured}) determined based on the measured velocity may be different from Δφ(v_{actual}) Thus, when the compensation phase determined for the measured velocity is used to compensate the Type-I residual phase, the residual phase after the Type-I residual phase compensation may be:

φ+Δφ(v_{actual})−Δφ(v_{measured})=φ+Δφ(\tilde{v}),

which is not equal to φ because v_{measured} is not equal to v_{actual}. The additional term Δφ(\tilde{v}) is caused by the Doppler aliasing and may be referred to herein as the Type-II residual phase. As such, the Type-I residual phase compensation technique described above may not be able to eliminate the residual phase for fast targets with velocities greater than the maximum Doppler velocity measuring interval Vₘₐₓ.

The Type-II residual phase for detected signals in the pth range-Doppler map (corresponding to the pth MIMO cycle) may be determined to be

$$\frac{2 π}{N} a p ,$$

where a is an aliasing factor for a range of velocities such as velocities between n×Vₘₐₓ and (n+1)×Vₘₐₓ. The Type-II residual phase can result in an infinite gain loss for a fast target having a velocity greater than V max, and thus may prevent the target from being detected, regardless of the size and/or the range of the target.

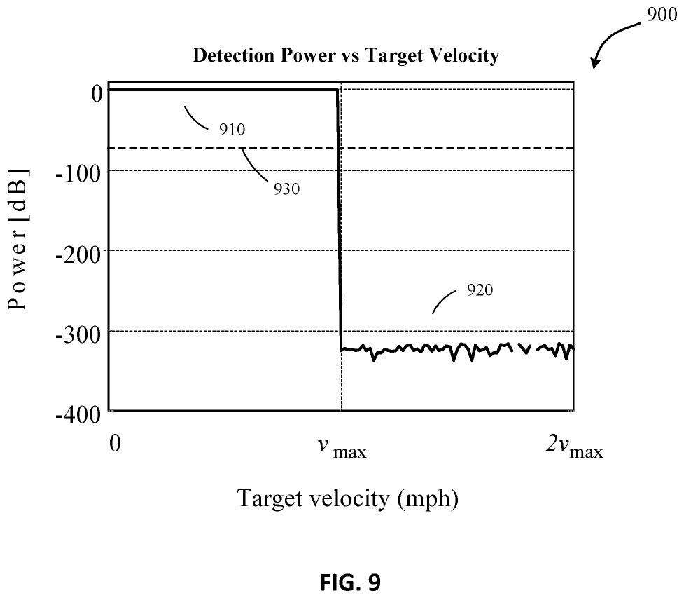

FIG. 9 includes a chart 900 illustrating an example of a result of compensating for Type-I residual phase in the presence of Doppler aliasing. Chart 900 includes a first region 910 where the velocities are lower than Vₘₐₓ and the residual phase caused by the motion of the target may be completely eliminated by the Type-I residual phase compensation described above, such that the gain loss may be about zero. Chart 900 also includes a second region 920 where the velocities are greater than Vₘₐₓ and where the compensation of the Type-I residual phase using the measured velocity may result in a close to zero amplitude for the detected signals. A line 930 in FIG. 9 shows an example of the lower threshold power that can be detected by a radar receiver. When the power of the detected signal for a target is below line 930, the target may not be detected. Thus, target with velocities in second region 920 may not be detected by the Doppler radar.

According to certain embodiments, a second phase compensation term CP may be used to compensate the Type-II residual phase of the detected signal associated with the pth MIMO cycle. Since the probability that the velocity of the target is between Vₘₐₓ and 2Vₘₐₓ may be higher than the probability that the velocity of the target is between 2Vₘₐₓ and 3Vₘₐₓ, ϕ₁p may be selected to be close to the Type-II residual phase for velocities between Vₘₐₓ and 2Vₘₐₓ, such that:

φ+Δφ(\tilde{v})−ϕ₁p=φ+Δφₘᵢₙ,

where Δφₘᵢₙ may be a small value. Even though second phase term ϕ₁p may not completely compensate the Type-II residual phase and may cause a certain gain loss for velocities lower than Vₘₐₓ because the detected signals for velocities lower than Vₘₐₓ do not have the Type-II residual phase, the gain loss may be small, such as less than about 3 dB. In some embodiments, ϕ₁p may be set to

$$\frac{2 π}{N} ap$$

as described above, where the aliasing factor a may be selected to be a value less than 1 and ϕ₁ may be set to

$$\frac{2 π}{N} a .$$

As such, both the Type-I residual phase and the Type-II residual phase may be compensated by multiplying the detected signal in the kth velocity bin of the range-Doppler map for the pth MIMO cycle by mₖₚ=e^{-2πi(ϕ}^{₀}^{kp+ϕ}^{₁}^{p)}, where −ϕ₀kp may be the opposite of the Type-I residual phase as described above and −ϕ₁p may be the opposite of the type-II residual phase. For example, ϕ₀ may be a constant

$$\frac{4 π {T}_{PRI} Δ v}{λ} or \frac{2 π}{N} ,$$

and ϕ₁ may be a constant

$$\frac{2 π}{N} a .$$

After the Type-I residual phase compensation and the Type-II residual phase compensation, the residual phase of the detected signal may be minimized or cancelled.

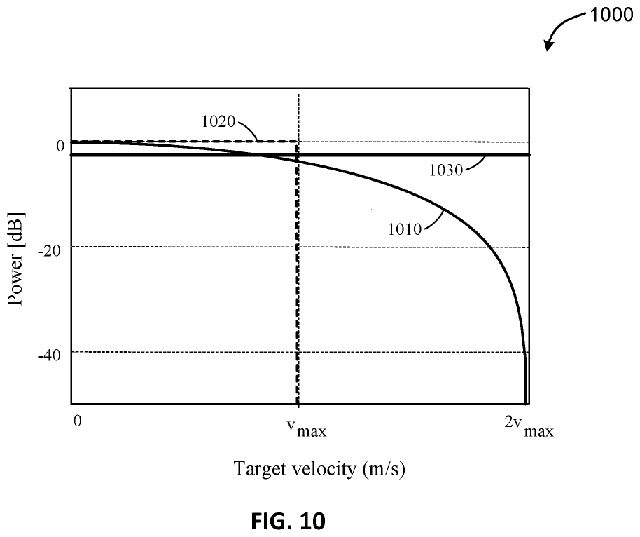

FIG. 10 includes a chart 1000 illustrating an example of a result of compensating residual phases in the presence of Doppler aliasing according to certain embodiments. The residual phases may be compensated by multiplying the detected signal in the kth velocity bin of the range-Doppler map for the pth MIMO cycle by mₖₚ=e^{-2πi(ϕ}^{₀}^{kp+ϕ}^{₁}^{p)} as described above. In chart 1000, a curve 1010 illustrates the power of the detected signal of a radar receiver without motion compensation, as a function of the velocity of the target that causes the detected signal. As described above, the power of the detected signal may decrease as the velocity of the target increases. A dashed line 1020 illustrates the power of the detected signal of a radar receiver with the Type-I residual phase compensation described above, as a function of the velocity of the target that causes the detected signal. Dashed line 1020 shows that the residual phase may be completely removed for targets with velocities less than Vₘₐₓ. But for targets with velocities greater than Vₘₐₓ, the gain loss may be very large such that the targets may not be detected. A line 1030 in FIG. 10 illustrates the power of the detected signal of a radar receiver with both the Type-I residual phase compensation and the Type-II residual phase compensation described above, as a function of the velocity of the target that causes the detected signal. Line 1030 shows that the gain loss for targets with velocities less than Vₘₐₓ and the gain loss for targets with velocities greater than Vₘₐₓ may be flattened and may be a small constant gain loss that may be less than about 3 dB.

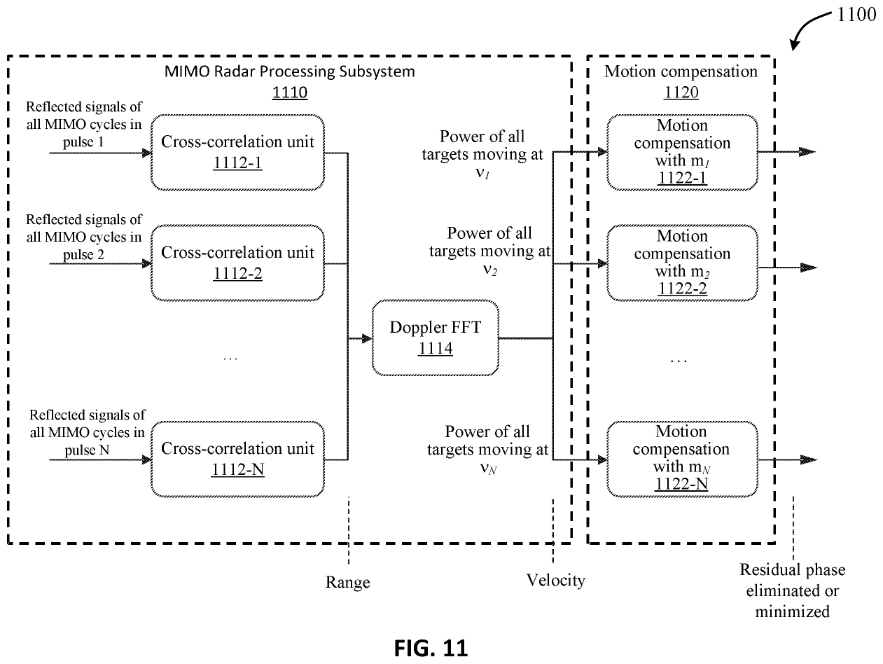

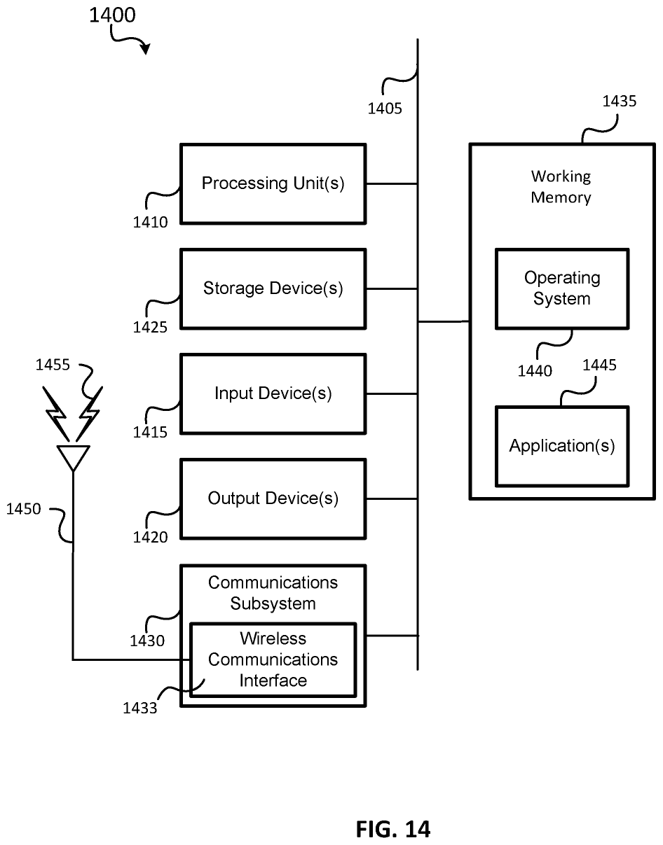

FIG. 11 illustrates an example of a Doppler processing system 1100 with motion compensation according to certain embodiments. Doppler processing system 1100 may be implemented using one or more computer systems, such as one or more computer system 1400 described in more detail below with respect to FIG. 14. Doppler processing system 1100 may include a MIMO radar processing subsystem 1110 that may be similar to Doppler processing subsystem 200. MIMO radar processing subsystem 1110 may receive captured echoes of N pulses each including P sub-pulses transmitted in P MIMO cycles. The captured echoes of each sub-pulse of the P sub-pulses in each pulse of the N pulses may be cross-correlated with the transmitted sub-pulse by a cross-correlation unit 1112-1, 1112-2, . . . , or 1112-N to determine the time delays of the echoes from targets and thus the ranges of the targets.

MIMO radar processing subsystem 1110 may also include a Doppler FFT unit 1114. As described above, Doppler FFT unit 1114 may perform multiple FFTs on captured echoes of the N pulses each including P sub-pulses transmitted in P MIMO cycles to convert the time domain signals to Doppler frequencies or velocities in different velocity bins. For example, as described above with respect to FIGS. 3A-4B, a two-dimensional Doppler FFT may be performed on the captured echoes of the pth sub-pulse transmitted in the pth MIMO cycle for all N pulses, where p may be an integer from 1 to P. The output of the two-dimensional Doppler FFT for each MIMO cycle may be filtered into N Doppler frequency or velocity bins as shown in FIG. 3B. Thus, a range-Doppler map may be generated for each of the P MIMO cycle based on the results of the two-dimensional Doppler FFT for each of the P MIMO cycle.

A motion compensation subsystem 1120 of Doppler processing system 1100 may perform the Type-I residual phase compensation and Type-II residual phase compensation described above using a set of motion compensation engines 1122-1, 1122-2, . . . , and 1122-N. Each motion compensation engine 1122-1, 1122-2, . . . , or 1122-N may apply residual phase compensation for targets with velocities in a same velocity bin. For example, as described above, a compensation phase −2π(ϕ₀kp+ϕ₁p) may be applied to a detected signal in the kth velocity bin on a range-Doppler map for the pth MIMO cycle, where ϕ₀ and ϕ₁ may be constant values as described above. In one example, the compensation phase may be applied to the detected signal by multiplying the detected signal with e^{-2πi(ϕ}^{₀}^{kp+ϕ}^{₁}^{p)}. A same compensation phase may be applied to each column (velocity bin) of the range-Doppler map such that the residual phases of detected signals for targets having the same velocity may be compensated similarly.

After the motion compensation by each of the set of motion compensation engines 1122-1, 1122-2, . . . , and 1122-N, the residual phase of the detected signals may be eliminated or minimized, such that the power of the detected signal representing a target with a velocity in any velocity bin may be unattenuated or may be minimally attenuated. The P motion-compensated range-Doppler maps for the P MIMO cycles may then be averaged or otherwise merged into an overall range-Doppler map as shown in, for example, FIG. 5B, 6A, or 7B.

In some embodiments, the phase compensation may be performed before the Doppler FFT. For example, when the number of pulses (N) is identical to the length of each one-dimensional Doppler FFT described above with respect to FIGS. 3A-3B, the received signals corresponding to the pth MIMO cycle of the kth pulse (e.g., after the cross-correction) may be multiplied by mₖₚ=e^{-2πi(ϕ}^{₀}^{′kp+ϕ}^{₁}^{′p)} where ϕ₀′ and ϕ₁′ are constant values. When the number of pulses (N) is not the same as the length of the one-dimensional Doppler FFT, the received signals corresponding to the pth MIMO cycle of the kth pulse may be multiplied by mₖₚ=e^{-2πi(ϕ}^{₀}^{″kp+ϕ}^{₁}^{″p)}, where ϕ₀″ and ϕ₁″ are constant values and may be determined based on the number of pulses, rather than the length of the one-dimensional Doppler FFT.

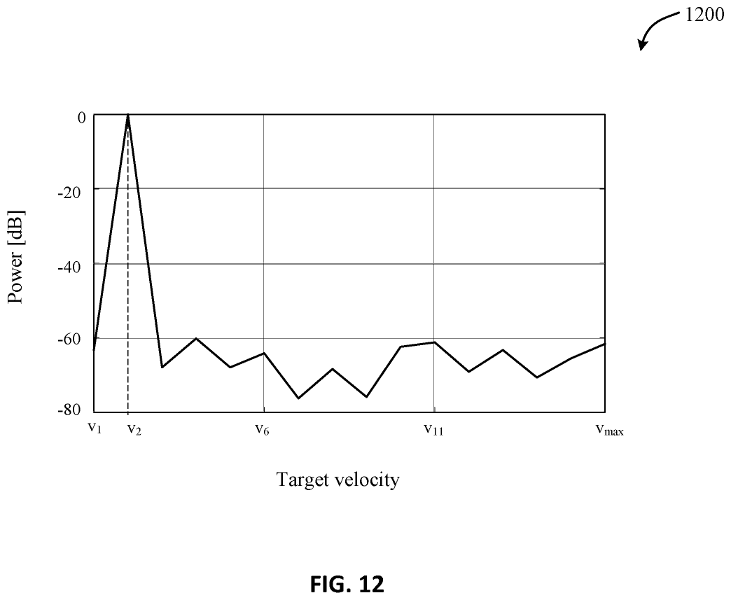

FIG. 12 includes a chart 1200 illustrating examples of outputs of a Doppler processing system (e.g., Doppler processing system 1100) with motion compensation according to certain embodiments. In the illustrated example, a target having a velocity v₂ may be present in the environment and may be detected. After the motion compensation for all velocity bins as described above, the echoes from the target may be detected with no or a minimal gain loss because of the Type-I residual phase compensation and the Type-II residual phase compensation. Since no targets having velocities in other frequency bins may be present in the environment and thus the signal power of the signals in other velocity bins may be very low, the motion compensation (e.g., multiplying by e^{-2πi(ϕ}^{₀}^{kp+ϕ}^{₁}^{p)}) may not or may only minimally affect the signal power of the signals in other velocity bins.

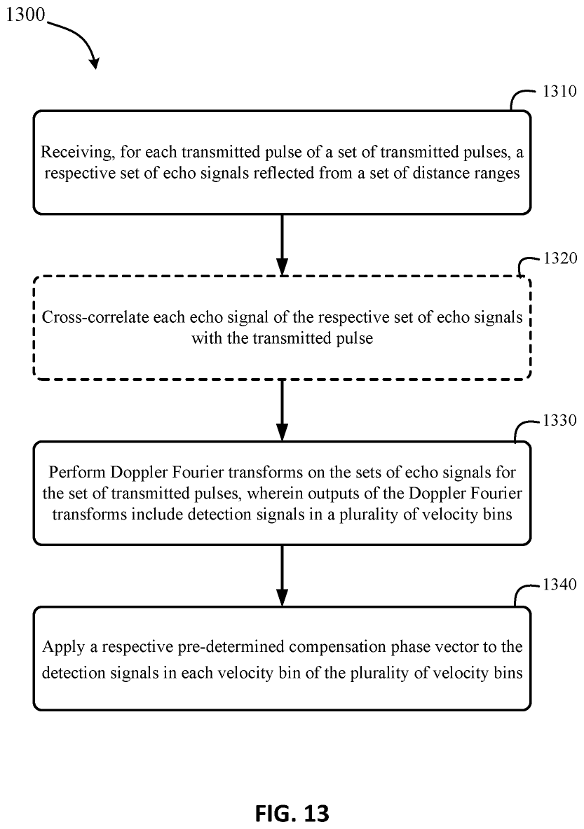

FIG. 13 includes a flowchart 1300 illustrating an example of a method of compensating residual phases in Doppler radars according to certain embodiments. Means for performing the functionality illustrated in one or more of the blocks shown in FIG. 13 may be performed by hardware and/or software components of a Doppler processing system or a computer system. Example components of a Doppler processing system are illustrated in FIG. 11 described above. Example components of a computer system are illustrated in FIG. 14, which are described in more detail below.

At block 1310, a Doppler processing system, such as Doppler processing system 1100, may receive, for each transmitted pulse of a set of transmitted pulses, a respective set of echo signals reflected from a plurality of distance ranges. The Doppler processing system may be part of a Doppler radar system. The Doppler radar system may include, for example, a MIMO radar system, where each transmitted pulse of the set of transmitted pulses may include a set of sub-pulses transmitted in a set of MIMO cycles, and the respective set of echo signals may include a respective subset of echo signals of each sub-pulse of the set of sub-pulses in the transmitted pulse. Each echo signal of the respective subset of echo signals may correspond to a respective distance range of the plurality of distance ranges. In some examples, the Doppler radar system may include an array of antennas, where each antenna or sub-array of antennas of the array of antennas may be configured to transmit a respective sub-pulse of the set of sub-pulses in a respective time slot of the set of time slots.

Optionally, at block 1320, the Doppler processing system, more specifically, one or more cross-correlation units (e.g., cross-correlation units 1112-1 to 1112-N) of the Doppler processing system, may cross-correlate each echo signal of the respective set of echo signals with the transmitted pulse (or sub-pulse). The cross-correlation may determine ranges of targets in the field of view. For example, the range of a target may be determined based on the delay of the transmitted pulse (or sub-pulse) to achieve the highest cross-correlation value with the echo signal.

At block 1330, the Doppler processing system, more specifically, a Doppler FFT unit (e.g., Doppler FFT unit 1114) of the Doppler processing system, may perform Doppler Fourier transforms on the sets of echo signals for the set of transmitted pulses. In some implementations, performing the Doppler Fourier transforms may include performing, for each MIMO cycle of the set of MIMO cycles, a respective two-dimensional Doppler Fourier transform on echo signals of sub-pulses transmitted in the MIMO cycle of the set of transmitted pulses. In some examples, the two-dimensional Doppler Fourier transform may include, for each distance range of the plurality of distance ranges, a respective one-dimensional Doppler Fourier transform on echo signals corresponding to sub-pulses transmitted in the MIMO cycle of the set of transmitted pulses and returned form the distance range. The outputs of the respective two-dimensional Doppler Fourier transform may include a plurality of signals, each signal of the plurality of signals associated with a range bin of a set of range bins and a velocity bin of the plurality of velocity bins. A detected signal of the detected signals in the plurality of velocity bins may indicate a target having a measured velocity with respect to the Doppler radar system, where an actual velocity of the target may be greater than a maximum Doppler velocity measuring interval of the Doppler radar system.

At block 1340, the Doppler processing system, more specifically, one or more motion compensation engines (e.g., motion compensation engines 1122-1 to 1122-N) of the Doppler processing system, may apply a respective pre-determined compensation phase vector to the detected signals in each velocity bin of the plurality of velocity bins. The respective pre-determined compensation phase vector applied to the detected signals in each velocity bin may include a first component proportional to a velocity of the velocity bin, and a second component for compensating a phase compensation error associated with Doppler velocity aliasing. In one example, applying the respective pre-determined compensation phase vector to the detected signals in a kth velocity bin of the plurality of velocity bins comprises multiplying detected signals in the kth velocity bin of the outputs of the two-dimensional Doppler Fourier transform for a pth MIMO cycle of the set of MIMO cycles by e^{-2πi(ϕ}^{₀}^{kp+ϕ}^{₁}^{p)}, where ϕ₀ and ϕ₁ are constant values, −ϕ₀kp may be used to compensate the Type-I residual phase, and −ϕ₁p may be used to compensate the Type-II residual phase. In some embodiments, the Doppler processing system may, after applying the respective pre-determined compensation phase vector to the detected signals in each velocity bin of the plurality of velocity bins average, average phase-compensated outputs of the two-dimensional Doppler Fourier transforms for the set of MIMO cycles to generate a range-Doppler map.

FIG. 14 is a block diagram of an embodiment of a computer system 1400, which may be used, in whole or in part, to provide the functions of one or more processing systems as described in the embodiments herein (e.g., Doppler FFT unit 230, cross-correlation units 1112-1 to 1112-N, Doppler FFT unit 1114, and motion compensation engines 1122-1, 1122-2, . . . , and 1122-N). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processing unit(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may send and receive wireless signals 1455 (e.g., signals according to 5G New Radio (NR) or Long-Term Evolution (LTE)) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other Tx/Rx Points (TRPs), and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of motion compensation in a Doppler radar system, the method comprising: receiving, for each transmitted pulse of a set of transmitted pulses, a respective set of echo signals returned from a plurality of distance ranges; performing Doppler Fourier transforms on the sets of echo signals for the set of transmitted pulses, wherein outputs of the Doppler Fourier transforms include detected signals in a plurality of velocity bins; and applying a respective pre-determined compensation phase vector to the detected signals in each velocity bin of the plurality of velocity bins.
Clause 2. The method of clause 1, wherein the respective pre-determined compensation phase vector applied to the detected signals in each velocity bin includes: a first component proportional to a velocity of the velocity bin; a second component for compensating a phase compensation error associated with Doppler velocity aliasing; or both.
Clause 3. The method of clause 1 or clause 2, wherein: the Doppler radar system includes a multiple-input-multiple-output (MIMO) radar system; each transmitted pulse of the set of transmitted pulses includes a set of sub-pulses transmitted in a set of MIMO cycles; and the respective set of echo signals for each transmitted pulse includes a respective subset of echo signals of each sub-pulse of the set of sub-pulses in the transmitted pulse.
Clause 4. The method of clause 3, wherein: each echo signal of the respective subset of echo signals corresponds to a respective distance range of the plurality of distance ranges; and performing the Doppler Fourier transforms comprises performing, for each MIMO cycle of the set of MIMO cycles, a respective two-dimensional Doppler Fourier transform on echo signals of sub-pulses transmitted in the MIMO cycle of the set of transmitted pulses.
Clause 5. The method of clause 4, wherein the two-dimensional Doppler Fourier transform comprises, for each distance range of the plurality of distance ranges, a respective one-dimensional Doppler Fourier transform on echo signals corresponding to sub-pulses transmitted in the MIMO cycle of the set of transmitted pulses and returned from the distance range.
Clause 6. The method of clause 5, wherein outputs of the respective two-dimensional Doppler Fourier transform include a plurality of detected signals, each detected signal of the plurality of detected signals associated with a range bin of a set of range bins and a velocity bin of the plurality of velocity bins.
Clause 7. The method of clause 6, wherein applying the respective pre-determined compensation phase vector to the detected signals in a kth velocity bin of the plurality of velocity bins comprises multiplying detected signals in the kth velocity bin of the outputs of the two-dimensional Doppler Fourier transform for a pth MIMO cycle of the set of MIMO cycles by e^{-2πi(ϕ}^{₀}^{kp+ϕ}^{₁}^{p)}, where ϕ₀ and ϕ₁ are constant values.
Clause 8. The method of any of clauses 4-7, further comprising averaging, after applying the respective pre-determined compensation phase vector to the detected signals in each velocity bin of the plurality of velocity bins, phase-compensated outputs of the two-dimensional Doppler Fourier transforms for the set of MIMO cycles to generate a range-Doppler map.
Clause 9. The method of any of clauses 3-8, further comprising cross-correlating, before performing the Doppler Fourier transforms, each echo signal of the respective subset of echo signals with the sub-pulse.
Clause 10. The method of any of clauses 1-9, wherein a detected signal of the detected signals in the plurality of velocity bins indicates a target having a measured velocity with respect to the Doppler radar system, and wherein an actual velocity of the target is greater than a maximum Doppler velocity measuring interval of the Doppler radar system.
Clause 11. A Doppler radar system comprising: a Doppler Fourier transform subsystem configured to: receive, for each transmitted pulse of a set of transmitted pulses, a respective set of echo signals returned from a plurality of distance ranges; and perform Doppler Fourier transforms on the sets of echo signals for the set of transmitted pulses, wherein outputs of the Doppler Fourier transforms include detected signals in a plurality of velocity bins; and a motion compensation subsystem configured to apply a respective pre-determined compensation phase vector to the detected signals in each velocity bin of the plurality of velocity bins.
Clause 12. The Doppler radar system of clause 11, wherein the respective pre-determined compensation phase vector applied to the detected signals in each velocity bin includes: a first component proportional to a velocity of the velocity bin; a second component for compensating a phase compensation error associated with Doppler velocity aliasing; or both the first component and the second component.
Clause 13. The Doppler radar system of clause 11 or clause 12, wherein: the Doppler radar system includes a multiple-input-multiple-output (MIMO) radar system; each transmitted pulse of the set of transmitted pulses includes a set of sub-pulses transmitted in a set of MIMO cycles; and the respective set of echo signals for each transmitted pulse includes a respective subset of echo signals of each sub-pulse of the set of sub-pulses in the transmitted pulse.
Clause 14. The Doppler radar system of clause 13, further comprising an array of antennas, wherein each antenna or sub-array of antennas of the array of antennas is configured to transmit a respective sub-pulse of the set of sub-pulses in a respective MIMO cycle of the set of MIMO cycles.
Clause 15. The Doppler radar system of any of clauses 13-14, wherein: each echo signal of the respective subset of echo signals corresponds to a respective distance range of the plurality of distance ranges; and the Doppler Fourier transforms comprise, for each MIMO cycle of the set of MIMO cycles, a respective two-dimensional Doppler Fourier transform on echo signals of sub-pulses transmitted in the MIMO cycle of the set of transmitted pulses.
Clause 16. The Doppler radar system of clause 15, wherein the two-dimensional Doppler Fourier transform comprises, for each distance range of the plurality of distance ranges, a respective one-dimensional Doppler Fourier transform on echo signals corresponding to sub-pulses transmitted in the MIMO cycle of the set of transmitted pulses and returned from the distance range.
Clause 17. The Doppler radar system of clause 16, wherein outputs of the respective two-dimensional Doppler Fourier transform include a plurality of detected signals, each detected signal of the plurality of detected signals associated with a range bin of a set of range bins and a velocity bin of the plurality of velocity bins.
Clause 18. The Doppler radar system of clause 17, wherein the motion compensation subsystem is configured to apply the respective pre-determined compensation phase vector to the detected signals in each velocity bin of the plurality of velocity bins by multiplying detected signals in the kth velocity bin of the outputs of the two-dimensional Doppler Fourier transform for a pth MIMO cycle of the set of MIMO cycles by e^{-2πi(ϕ}^{₀}^{kp+ϕ}^{₁}^{p)}, where ϕ₀ and ϕ₁ are constant values.
Clause 19. The Doppler radar system of any of clauses 15-18, further comprising a map generator configured to average, after the motion compensation subsystem applying the respective pre-determined compensation phase vector to the detected signals in each velocity bin of the plurality of velocity bins, phase-compensated outputs of the two-dimensional Doppler Fourier transforms for the set of MIMO cycles to generate a range-Doppler map.
Clause 20. The Doppler radar system of any of clauses 13-19, further comprising a cross-correlation subsystem configured to cross-correlate, before the Doppler Fourier transform subsystem performing the Doppler Fourier transforms, each echo signal of the respective subset of echo signals with the sub-pulse.
Clause 21. The Doppler radar system of any of clauses 11-20, wherein the motion compensation subsystem comprises a set of motion compensation engines, each motion compensation engine of the set of motion compensation engines configured to apply the respective pre-determined compensation phase vector to the detected signals in a respective velocity bin of the plurality of velocity bins.
Clause 22. The Doppler radar system of any of clauses 11-21, wherein a detected signal of the detected signals in the plurality of velocity bins indicates a target having a measured velocity with respect to the Doppler radar system, and wherein an actual velocity of the target is greater than a maximum Doppler velocity measuring interval of the Doppler radar system.
Clause 23. A device for motion compensation in a Doppler radar system, the device comprising: means for receiving, for each transmitted pulse of a set of transmitted pulses, a respective set of echo signals returned from a plurality of distance ranges; means for performing Doppler Fourier transforms on the sets of echo signals for the set of transmitted pulses, wherein outputs of the Doppler Fourier transforms include detected signals in a plurality of velocity bins; and means for applying a respective pre-determined compensation phase vector to the detected signals in each velocity bin of the plurality of velocity bins.
Clause 24. The device of clause 23, wherein the respective pre-determined compensation phase vector applied to the detected signals in each velocity bin includes: a first component proportional to a velocity of the velocity bin; and a second component for compensating a phase compensation error associated with Doppler velocity aliasing.
Clause 25. The device of any of clauses 23-24, wherein: each transmitted pulse of the set of transmitted pulses includes a set of sub-pulses transmitted in a set of cycles; the device further comprises means for transmitting a respective sub-pulse of the set of sub-pulses in a respective cycle of the set of cycles; the respective set of echo signals for each transmitted pulse includes a respective subset of echo signals of each sub-pulse of the set of sub-pulses in the transmitted pulse; the Doppler Fourier transforms comprise, for each cycle of the set of cycles, a respective two-dimensional Doppler Fourier transform on echo signals of sub-pulses transmitted in the cycle of the set of transmitted pulses; and outputs of the respective two-dimensional Doppler Fourier transform include a plurality of detected signals, each detected signal of the plurality of detected signals associated with a range bin of a set of range bins and a velocity bin of the plurality of velocity bins.
Clause 26. The device of clause 25, wherein the means for applying the respective pre-determined compensation phase vector to the detected signals in a kth velocity bin of the plurality of velocity bins comprises means for multiplying detected signals in the kth velocity bin of the outputs of the two-dimensional Doppler Fourier transform for a pth cycle of the set of cycles by e−2πiϕ0kp+ϕ1p, where ϕ0 and ϕ1 are constant values.
Clause 27. The device of any of clauses 25-26, further comprising means for averaging phase-compensated outputs of the two-dimensional Doppler Fourier transforms for the set of cycles to generate a range-Doppler map.
Clause 28. The device of any of clauses 25-27, further comprising means for cross-correlating, before the Doppler Fourier transforms, each echo signal of the respective subset of echo signals with the sub-pulse.
Clause 29. A non-transitory computer-readable medium having instructions embedded thereon, which, when executed by one or more processing units, cause the one or more processing units to perform operations comprising: receiving, for each transmitted pulse of a set of transmitted pulses, a respective set of echo signals returned from a plurality of distance ranges; performing Doppler Fourier transforms on the sets of echo signals for the set of transmitted pulses, wherein outputs of the Doppler Fourier transforms include detected signals in a plurality of velocity bins; and applying a respective pre-determined compensation phase vector to the detected signals in each velocity bin of the plurality of velocity bins.
Clause 30. The non-transitory computer-readable medium of clause 29, wherein the respective pre-determined compensation phase vector applied to the detected signals in each velocity bin includes: a first component proportional to a velocity of the velocity bin; and a second component for compensating a phase compensation error associated with Doppler velocity aliasing.

What is claimed is:

1. A method of motion compensation in a Doppler radar system, the method comprising:
receiving, for each transmitted pulse of a set of transmitted pulses, a respective set of echo signals returned from a plurality of distance ranges;
performing Doppler Fourier transforms on the sets of echo signals for the set of transmitted pulses, wherein outputs of the Doppler Fourier transforms include detected signals in a plurality of velocity bins; and
applying a respective pre-determined compensation phase vector to the detected signals in each velocity bin of the plurality of velocity bins.

2. The method of claim 1, wherein the respective pre-determined compensation phase vector applied to the detected signals in each velocity bin includes:
a first component proportional to a velocity of the velocity bin;
a second component for compensating a phase compensation error associated with Doppler velocity aliasing; or
both the first component and the second component.

3. The method of claim 1, wherein:
the Doppler radar system includes a multiple-input-multiple-output (MIMO) radar system;
each transmitted pulse of the set of transmitted pulses includes a set of sub-pulses transmitted in a set of MIMO cycles; and
the respective set of echo signals for each transmitted pulse includes a respective subset of echo signals of each sub-pulse of the set of sub-pulses in the transmitted pulse.

4. The method of claim 3, wherein:
each echo signal of the respective subset of echo signals corresponds to a respective distance range of the plurality of distance ranges; and
performing the Doppler Fourier transforms comprises performing, for each MIMO cycle of the set of MIMO cycles, a respective two-dimensional Doppler Fourier transform on echo signals of sub-pulses transmitted in the MIMO cycle of the set of transmitted pulses.

5. The method of claim 4, wherein the two-dimensional Doppler Fourier transform comprises, for each distance range of the plurality of distance ranges, a respective one-dimensional Doppler Fourier transform on echo signals corresponding to sub-pulses transmitted in the MIMO cycle of the set of transmitted pulses and returned from the distance range.

6. The method of claim 5, wherein outputs of the respective two-dimensional Doppler Fourier transform include a plurality of detected signals, each detected signal of the plurality of detected signals associated with a range bin of a set of range bins and a velocity bin of the plurality of velocity bins.

7. The method of claim 6, wherein applying the respective pre-determined compensation phase vector to the detected signals in a kth velocity bin of the plurality of velocity bins comprises multiplying detected signals in the kth velocity bin of the outputs of the two-dimensional Doppler Fourier transform for a pth MIMO cycle of the set of MIMO cycles by e^{-2πi(ϕ}^{₀}^{kp+ϕ}^{₁}^{p)} where ϕ₀ and ϕ₁ are constant values.

8. The method of claim 4, further comprising averaging, after applying the respective pre-determined compensation phase vector to the detected signals in each velocity bin of the plurality of velocity bins, phase-compensated outputs of the two-dimensional Doppler Fourier transforms for the set of MIMO cycles to generate a range-Doppler map.

9. The method of claim 3, further comprising cross-correlating, before performing the Doppler Fourier transforms, each echo signal of the respective subset of echo signals with the sub-pulse.

10. The method of claim 1, wherein a detected signal of the detected signals in the plurality of velocity bins indicates a target having a measured velocity with respect to the Doppler radar system, and wherein an actual velocity of the target is greater than a maximum Doppler velocity measuring interval of the Doppler radar system.

11. A Doppler radar system comprising:
a Doppler Fourier transform subsystem configured to:
receive, for each transmitted pulse of a set of transmitted pulses, a respective set of echo signals returned from a plurality of distance ranges; and
perform Doppler Fourier transforms on the sets of echo signals for the set of transmitted pulses, wherein outputs of the Doppler Fourier transforms include detected signals in a plurality of velocity bins; and
a motion compensation subsystem configured to apply a respective pre-determined compensation phase vector to the detected signals in each velocity bin of the plurality of velocity bins.

12. The Doppler radar system of claim 11, wherein the respective pre-determined compensation phase vector applied to the detected signals in each velocity bin includes:
a first component proportional to a velocity of the velocity bin;
a second component for compensating a phase compensation error associated with Doppler velocity aliasing; or
both the first component and the second component.

13. The Doppler radar system of claim 11, wherein:
the Doppler radar system includes a multiple-input-multiple-output (MIMO) radar system;
each transmitted pulse of the set of transmitted pulses includes a set of sub-pulses transmitted in a set of MIMO cycles; and
the respective set of echo signals for each transmitted pulse includes a respective subset of echo signals of each sub-pulse of the set of sub-pulses in the transmitted pulse.

14. The Doppler radar system of claim 13, further comprising an array of antennas, wherein each antenna or sub-array of antennas of the array of antennas is configured to transmit a respective sub-pulse of the set of sub-pulses in a respective MIMO cycle of the set of MIMO cycles.

15. The Doppler radar system of claim 13, wherein:
each echo signal of the respective subset of echo signals corresponds to a respective distance range of the plurality of distance ranges; and
the Doppler Fourier transforms comprise, for each MIMO cycle of the set of MIMO cycles, a respective two-dimensional Doppler Fourier transform on echo signals of sub-pulses transmitted in the MIMO cycle of the set of transmitted pulses.

16. The Doppler radar system of claim 15, wherein the two-dimensional Doppler Fourier transform comprises, for each distance range of the plurality of distance ranges, a respective one-dimensional Doppler Fourier transform on echo signals corresponding to sub-pulses transmitted in the MIMO cycle of the set of transmitted pulses and returned from the distance range.

17. The Doppler radar system of claim 16, wherein outputs of the respective two-dimensional Doppler Fourier transform include a plurality of detected signals, each detected signal of the plurality of detected signals associated with a range bin of a set of range bins and a velocity bin of the plurality of velocity bins.

18. The Doppler radar system of claim 17, wherein the motion compensation subsystem is configured to apply the respective pre-determined compensation phase vector to the detected signals in each velocity bin of the plurality of velocity bins by multiplying detected signals in the kth velocity bin of the outputs of the two-dimensional Doppler Fourier transform for a pth MIMO cycle of the set of MIMO cycles by e^{-2πi(ϕ}^{₀}^{kp+ϕ}^{₁}^{p)}, where ϕ₀ and ϕ₁ are constant values.

19. The Doppler radar system of claim 15, further comprising a map generator configured to average, after the motion compensation subsystem applying the respective pre-determined compensation phase vector to the detected signals in each velocity bin of the plurality of velocity bins, phase-compensated outputs of the two-dimensional Doppler Fourier transforms for the set of MIMO cycles to generate a range-Doppler map.

20. The Doppler radar system of claim 13, further comprising a cross-correlation subsystem configured to cross-correlate, before the Doppler Fourier transform subsystem performing the Doppler Fourier transforms, each echo signal of the respective subset of echo signals with the sub-pulse.

21. The Doppler radar system of claim 11, wherein the motion compensation subsystem comprises a set of motion compensation engines, each motion compensation engine of the set of motion compensation engines configured to apply the respective pre-determined compensation phase vector to the detected signals in a respective velocity bin of the plurality of velocity bins.

22. The Doppler radar system of claim 11, wherein a detected signal of the detected signals in the plurality of velocity bins indicates a target having a measured velocity with respect to the Doppler radar system, and wherein an actual velocity of the target is greater than a maximum Doppler velocity measuring interval of the Doppler radar system.

23. A device for motion compensation in a Doppler radar system, the device comprising:
means for receiving, for each transmitted pulse of a set of transmitted pulses, a respective set of echo signals returned from a plurality of distance ranges;
means for performing Doppler Fourier transforms on the sets of echo signals for the set of transmitted pulses, wherein outputs of the Doppler Fourier transforms include detected signals in a plurality of velocity bins; and
means for applying a respective pre-determined compensation phase vector to the detected signals in each velocity bin of the plurality of velocity bins.

24. The device of claim 23, wherein the respective pre-determined compensation phase vector applied to the detected signals in each velocity bin includes:
a first component proportional to a velocity of the velocity bin; and
a second component for compensating a phase compensation error associated with Doppler velocity aliasing.

25. The device of claim 23, wherein:
each transmitted pulse of the set of transmitted pulses includes a set of sub-pulses transmitted in a set of cycles;
the device further comprises means for transmitting a respective sub-pulse of the set of sub-pulses in a respective cycle of the set of cycles;
the respective set of echo signals for each transmitted pulse includes a respective subset of echo signals of each sub-pulse of the set of sub-pulses in the transmitted pulse;
the Doppler Fourier transforms comprise, for each cycle of the set of cycles, a respective two-dimensional Doppler Fourier transform on echo signals of sub-pulses transmitted in the cycle of the set of transmitted pulses; and
outputs of the respective two-dimensional Doppler Fourier transform include a plurality of detected signals, each detected signal of the plurality of detected signals associated with a range bin of a set of range bins and a velocity bin of the plurality of velocity bins.

26. The device of claim 25, wherein the means for applying the respective pre-determined compensation phase vector to the detected signals in a kth velocity bin of the plurality of velocity bins comprises means for multiplying detected signals in the kth velocity bin of the outputs of the two-dimensional Doppler Fourier transform for a pth cycle of the set of cycles by e^{-2πi(ϕ}^{₀}^{kp+ϕ}^{₁}^{p)}, where ϕ₀ and ϕ₁ are constant values.

27. The device of claim 25, further comprising means for averaging phase-compensated outputs of the two-dimensional Doppler Fourier transforms for the set of cycles to generate a range-Doppler map.

28. The device of claim 25, further comprising means for cross-correlating, before the Doppler Fourier transforms, each echo signal of the respective subset of echo signals with the sub-pulse.

29. A non-transitory computer-readable medium having instructions embedded thereon, which, when executed by one or more processing units, cause the one or more processing units to perform operations comprising:
receiving, for each transmitted pulse of a set of transmitted pulses, a respective set of echo signals returned from a plurality of distance ranges;
performing Doppler Fourier transforms on the sets of echo signals for the set of transmitted pulses, wherein outputs of the Doppler Fourier transforms include detected signals in a plurality of velocity bins; and
applying a respective pre-determined compensation phase vector to the detected signals in each velocity bin of the plurality of velocity bins.

30. The non-transitory computer-readable medium of claim 29, wherein the respective pre-determined compensation phase vector applied to the detected signals in each velocity bin includes:
a first component proportional to a velocity of the velocity bin; and
a second component for compensating a phase compensation error associated with Doppler velocity aliasing.
